(19) United States
(12) Patent Application Publication
(10) Pub. No.: US 2010/0276420 A1
(43) Pub. Date: Nov. 4, 2010

(54) BEVERAGE CONTAINER MADE OF SALT AND RELATED METHOD

(76) Inventors: Mary Porter McKee, Lexington, KY (US); John R. Tucker, JR., Lexington, KY (US)

Correspondence Address: KING & SCHICKLI, PLLC, 247 NORTH BROADWAY, LEXINGTON, KY, 40507, US

(21) Appl. No.: 12/770,048

(22) Filed: Apr. 29, 2010

Related U.S. Application Data
(60) Provisional application No. 61/174,032, filed on Apr. 30, 2009.

(51) Int. Cl. A47G 19/22; B05D 7/22; B24B 1/00

(52) U.S. Cl. 220/62.12; 427/230; 451/54

(57) ABSTRACT

A method of making a beverage container from salt including cutting the salt into a block. A center portion of the block is removed to form a hollow interior portion for receiving a liquid. The block is polished to create smooth sides and rounded edges for the container. A wax coating may be applied to an exterior portion of the block. Further, an indicia may be attached to the wax coating.

This application claims the benefit of U.S. Provisional Patent Application Ser. No. 61/174,032, filed on Apr. 30, 2009, the disclosure of which is incorporated herein by reference.

### FIELD OF THE INVENTION

The present invention relates generally to a container, and more particularly, to a beverage container made of salt, such as a shot glass, margarita glass, or drinking glass/cup that enhances the flavor and taste of the beverage and a related method of making the same.

### BACKGROUND OF THE INVENTION

Salt is a well-known chemical compound composed of primarily sodium chloride (formula NaCl) that is essential for all living creatures, including humans. Salt for human consumption may take different forms, such as unrefined salt (sea salt), refined salt (table salt) and iodized salt. Salt is a crystalline solid, which may come in multiple colors, including white, pink, black, blue or light gray in color. It is typically obtained from sea water or rock deposits. One particular type of salt is Himalayan salt, which is mined by hand in quarries in the interior of the foothills of the Himalayan Mountains. Himalayan salt may be in a variety of colors, including white, pink, black and blue. Himalayan salt is over 250 million years old and is not contaminated by any toxins or pollution which can affect other types of salt. As a result, it is generally purer than traditional sea salt and, thus, has a unique flavor.

Salt has been used for centuries in a number of different applications, including but not limited to: food preservation, a condiment for food and drink, de-icing driveways and patches of ice, cleaning agent, and treatment of various medical ailments. Traditionally, it is perhaps best known for its distinctive taste. As a result, it is a popular condiment for seasoning a number of foods (i.e., popcorn and french fries) and drinks (i.e., tequila shots, margaritas, bloody marys and other mixed drinks). Specifically, salt may be added to a number of alcohol drinks to bring out and enhance the flavor of the alcohol drink. Although salt is perhaps best known for its use with tequila-based drinks, it is also commonly used with vodka, rum, saki, beer, bourbon, tomato juice, chocolate liqueur and other mixed drinks.

As mentioned above, it is also known to use salt in certain medical treatments for treating various minor ailments, such as sore throats, toothaches, postnasal drip, bee stings, mosquito bites, sore gums and poison ivy and oak. In more detail, a warm saltwater gargle or rinse is often used to treat minor sore throat pain. For example, one teaspoon of salt may be mixed with eight ounces of warm water and gargled by the user to improve health and hygiene. In addition, toothaches and gum pain may be treated with a saltwater rinse consisting of a mixture of 1 teaspoon of salt with 4 ounces of warm water.

In order to use salt for the various purposes described above, including enhancing the flavor of drinks or treating minor medical ailments, salt (usually in the form of table salt) must be added to the food, drink or water. Of course, this requires using a salt shaker or an individual packet of salt to add to the beverage or container. It would be advantageous in terms of cost and efficiency to have beverage containers made of salt to avoid the time and expense related to adding salt to each drink, such as a margarita or martini at a restaurant or bar. Generally, beverage containers such as shot glasses are formed of glass and may be in various shapes (i.e., rectangular or square) and sizes (a typical shot is approximately one ounce). Accordingly, there is a need for a beverage container made of salt to enhance the flavor of the beverage while eliminating the need for the addition of salt to the beverage. Importantly, the beverage container should be capable of multiple uses (after cleaning) and should not produce too much of a salty taste per each use. Finally, the beverage container should be relatively easy and economically feasible to use and manufacture.

### SUMMARY OF THE INVENTION

The above-mentioned and other problems become solved by applying the principles and teachings associated with the hereinafter described beverage container made of salt and related method.

In a basic sense, the beverage container such as a shot glass is made from a salt stone. The salt stone is selected and cut into a block, such as the shape of a rectangle. A center portion of the block is removed to form a hollow interior portion for receiving a beverage. The block is polished to allow a user to drink from the beverage container. Advantageously, the beverage container made from salt enhances the flavor of the beverage while eliminating the need for the addition of salt to the beverage.

In one embodiment, the invention teaches applying a wax coating, such as a paraffin wax to an exterior portion of the container. In more detail, a solid wax is heated until it turns into a liquid. The block is dipped into the liquid and allowed to cool. Preferably, the top portion is not coated with the wax coating in order to allow the user to “taste” the salt during use rather than the wax coating. In addition, an indicia, such as a trademark, logo, decorative medallion and/or other design may be attached to the wax coating.

In other aspects of the invention, the salt block is placed into a lathe to create rounded edges for the beverage container. In order to remove the center portion of the block, the block may be drilled to a desired depth. Subsequently, a dowel may be placed into the center portion and used to pop the portion out of the block to create the hollow interior portion of the container.

These and other embodiments, aspects, advantages, and features of the present invention will be set forth in the description which follows, and in part will become apparent to those of ordinary skill in the art by reference to the following description of exemplary embodiments of the invention and referenced drawings or by practice of the invention. The aspects, advantages, and features of the invention are realized and attained according to the following description and as particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a perspective view in accordance with one embodiment of the present invention of a beverage container;

FIG. 2 is a top view in accordance with one embodiment of the present invention of the beverage container;

FIG. 3 is a representative bottom view in accordance with one embodiment of the present invention of the beverage container;

FIG. 4 is a front view in accordance with one embodiment of the present invention of the beverage container; and

FIG. 5 is a cross-sectional view in accordance with one embodiment of the present invention of the beverage container.

### DETAILED DESCRIPTION OF THE INVENTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process or other changes may be made without departing from the scope of the present invention. The following detailed description is, therefore, not to be taken in a limiting sense, and the scope of the present invention is defined only by the appended claims and their equivalents. In accordance with the present invention, a beverage container made of salt and related methods of making the same is hereinafter described.

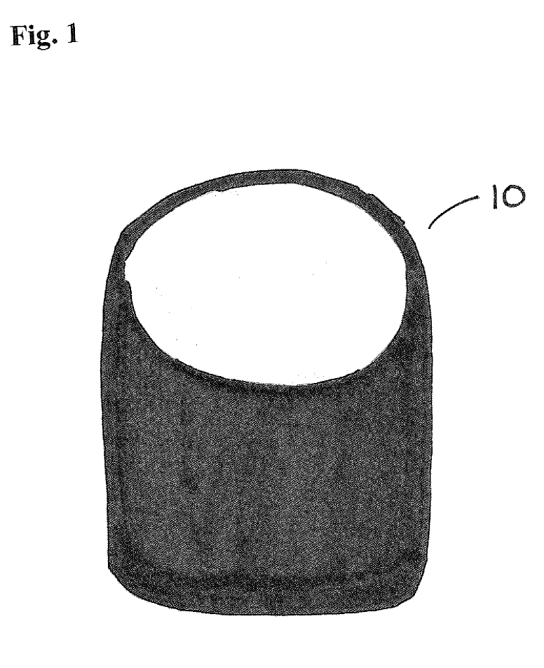

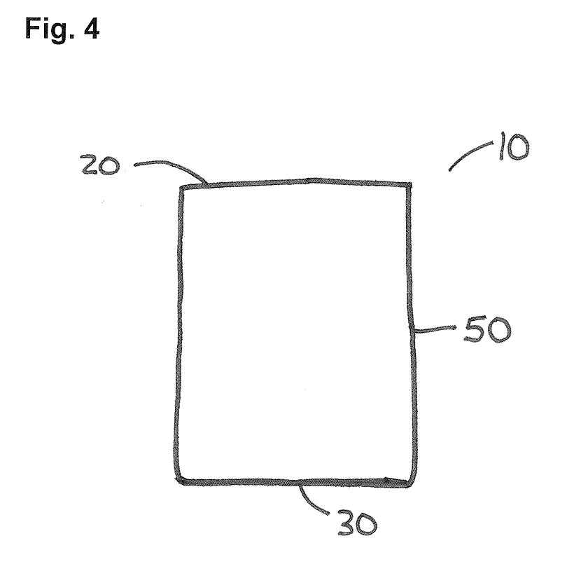

As shown in FIGS. 1-5, a beverage container 10 made from Himalayan pink salt is illustrated. In this embodiment, the beverage container 10 is a shot glass. However, the beverage container 10 may be in the form of a drinking glass or cup, margarita glass and the like. Of course, it should be appreciated that the beverage container 10 may be made from types of salt other than Himalayan pink salt. Furthermore, the beverage container 10 may be made in a variety of different sizes, styles and colors, such as white, blue and black.

Advantageously, the subtle flavor of the shot glass carved from salt, adds to and enhances the taste of beverages ranging from tomato juice to tequila and other alcohol based mixed drinks contained within the shot glass. An additional use of the beverage container carved from salt is as a salt rinse. Specifically, warm water may be added to the shot glass and allowed to sit for about one minute and then a person may gargle the salt water to promote health and hygiene. Importantly, the shot glass carved from salt eliminates the need for adding salt to the glass and, thus, improves the efficiency of a bar or restaurant and reduces expenses.

Himalayan salt is mined as slabs from the Himalayan Mountains. In other embodiments, salt may be mined from other areas, including the United States. Typically, the stones of salt are fragile depending on the veining and are usually selected from the quarry by hand. A very high quality stone should be used in order to create a shot glass free of fractures and veins. In order to identify this type of stone, a bright light inspection process may be used to visually identify any internal veins or fractures. Once the stones are identified and selected, they are cut into blocks that are suitable for a lathe. In more detail, the stones are cut into blocks that are in the shape of a rectangle, approximately 6.5 centimeters by 6.5 centimeters and 9 centimeters in height.

In one embodiment, a diamond wet saw is used to cut the blocks into the appropriate size. The block is placed into a lathe in order to create rounded edges on the rim 20 and near the base 30 of the shot glass 10. In addition to the lathe, a diamond tipped gauge may be used to make the cut necessary to shape the block. Specifically, the block is centered in between the chuck and the drive head of the lathe. Once the lathe is turning, the gauge is placed on the rest of the lathe and additional salt is shaved off the block to produce the desired shape and size. Once shaped appropriately to a diameter of approximately six centimeters, the block is polished with a 220 grit sandpaper to smooth out the sides and to round the edges for appearance. Once the smoothing/polishing process is complete, the block is removed from the lathe.

Subsequently, the rounded block is placed into a padded vice and a center piece of the block is punched with a three centimeter carbide grit hole saw by centering the hole saw bit and drilling to a depth of approximately seven centimeters into the block. Once drilled, the center piece is removed by placing a metal dowel into the center piece and popping loose the core to create a hollow center portion 40. Finally, the hollow center portion 40 of the block is smoothed out to a depth of approximately seven centimeters with an one-inch carbide tipped drill bit.

Alternatively, the glasses and cups may be made by injection molding. Specifically, a salt solution is mixed with additives and then the solution is compressed under high pressure to form the molding. These glasses and cups are opaque rather than the translucent glasses and cups formed by carving. The solution used in the injection molding process may be flavored and/or colored to fit the parameters of the end user. In another embodiment, the beverage containers may be made by hand with a drill and a sander for final shaping. In other embodiments, the center of the shot glass 10 is removed and then an exterior portion is carved into a curved outside portion or in the form of a yin or yang curve. Subsequently, the exterior portion is polished with water and a sanding cloth.

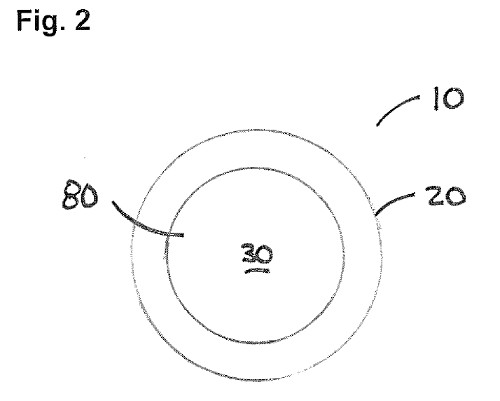

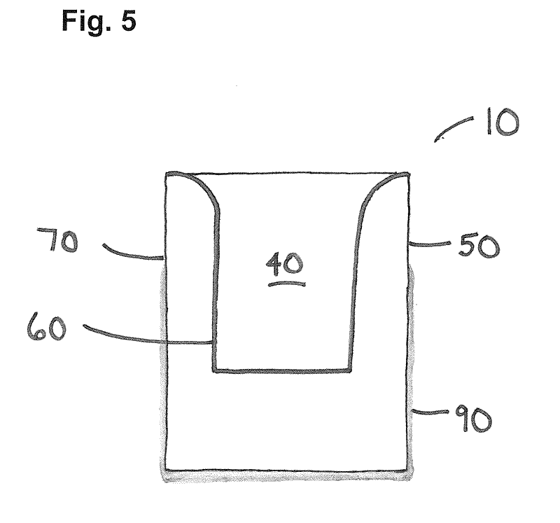

As illustrated in FIGS. 1-5, the shot glass 10 is substantially cylindrical having a side wall 50 which is circular in cross-section. The side wall has an inner portion 60 and an exterior portion 70. The side wall 50 extends and slopes slightly downward and inward from a wider upper opening 80 to a base 30. As best shown in FIG. 2, the upper opening 80 has an outer diameter of approximately six centimeters and an inner diameter of approximately three centimeters. The center portion 40 of the shot glass 10 cut from the inner portion 30 of the side wall 20 and is designed to receive and hold the beverage. As best shown in FIG. 5, the center portion 40 extends from the rim 20 to about two centimeters from the base. Of course, it should be appreciated that the beverage containers may come in a variety of shapes and sizes. In one embodiment, the shot glass 10 is approximately nine centimeters in height and six centimeters in length. The center portion (for holding the beverage) is approximately seven centimeters by three centimeters. The diameter of the center portion is approximately three centimeters.

Once the shot glass 10 is formed and the polishing and smoothing steps are completed, a wax coating 90 may be provided to the shot glass 10. Advantageously, the wax coating 90 increases the life of the salt shot glass 10 as well as creating a decorative finish for the shot glass. In order to coat the salt shot glass, a wax solid is heated until it forms a liquid. In one embodiment, the wax used may be paraffin wax, which has a typical melting point between 47° C. and 64° C. (116.6° F. to 147.2° F.). The shot glass 10 is then dipped into the wax bottom first, up to a depth of approximately seven centimeters in order to leave room at the top of the glass exposed (approximately two centimeters from the rim) for both aesthetics and function. Namely, the top of the glass should not be covered with wax in order to allow the user to “taste” the salt when drinking or “shooting” a particular beverage. Typically, each shot glass 10 is dipped into the wax once and turned until the wax cools enough to slow the flow of the hot wax.

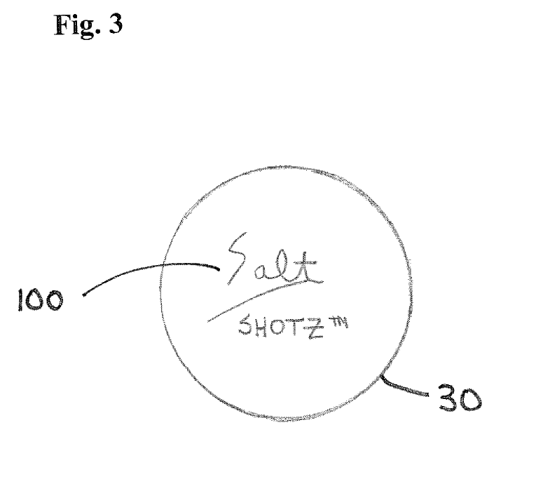

As shown in FIG. 3, once the wax coating is complete, indicia, such as trademarks, logos, decorative medallions and/or other designs 100 may be imprinted or attached to the shot glass. The wax coating can be applied in any color and indicia, such as decorative medallions and logos may be added to increase the marketing value of the product. This is particular advantageous for restaurant and bar owners to imprint or attach their logo into the containers for use at their stores and/or sale to consumers for souvenirs. Preferably, the decorative medallions or logos may be attached by heating the back of the medallion with a torch and attaching it to the wax exterior of the cup. Of course, it should be appreciated that the medallions, logos and the like may be attached in other ways, such as by adhesive. Alternatively, sand blasting and/or engraving may be used to imprint the designs 40 onto the bottom 50 of the beverage container 10 or the side of the beverage container. Engraving is usually performed directly on the glass rather than on the wax coating.

One of the primary advantages of the shot glasses or beverage containers is a container that promotes the sale of alcohol shots, such as tequila, vodka, gin as well as specialty drinks, such as margaritas, martinis, bloody marys, screw drivers, beer and saki. Another advantage of these glasses and cups over standard bar glasses other than the unique color and appeal of the material is the flavor that is given to the particular shot or drink as the result of the use of salt, including Himalayan salt. In addition, these glasses and cups eliminate the need to add salt (i.e., in the form of individual salt packets or from a salt shaker, etc.) to the alcoholic drink or to warm water for treating minor medical ailments. Finally, these glasses and cups may be easily manufactured.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A method for making a beverage container from salt, comprising:
cutting the salt into a block;
removing a center portion of the block to form a hollow interior portion for receiving a liquid; and
polishing the block.

2. The method of claim 1, further comprising placing the block into a lathe to create rounded edges for the container.

3. The method of claim 1, further comprising shaving additional salt from the block.

4. The method of claim 1, wherein the removing includes drilling into the block to a desired depth.

5. The method of claim 4, wherein the removing further includes placing a dowel into the center portion and popping said portion out of the block.

6. The method of claim 1, wherein the polishing includes smoothing the sides of the block and rounding the edges of the block.

7. The method of claim 1, further comprising applying a wax coating to an exterior portion of the block.

8. The method of claim 7, wherein the applying includes heating the wax coating until it turns into a liquid.

9. The method of claim 8, wherein the applying includes dipping the block into the liquid wax coating.

10. The method of claim 9, wherein the applying includes leaving a top portion of the block free from the wax coating.

11. The method of claim 7, further comprising attaching an indicia to the wax coating.

12. The method of claim 11, wherein the attaching includes heating the indicia to allow it to attach to the wax coating.

13. A method for making a shot glass from Himalayan salt, comprising:
cutting the salt into a rectangular block;
placing the block into a lathe to create rounded edges of the shot glass;
removing a center portion of the block to form a hollow interior portion for receiving a liquid surrounded by an exterior portion;
applying a wax coating to the exterior portion; and
attaching an indicia to the wax coating.

14. The method of claim 13, wherein the applying includes dipping the exterior portion into the wax coating such that a top portion of the glass is not coated with the wax coating.

15. A beverage container carved from salt, comprising:
a substantially cylindrical body having a open top portion and a base;
a hollow interior portion extending between the top portion and the base for holding a liquid; and
a wax coating on the cylindrical body.

16. The beverage container of claim 15, wherein an indicia is attached to the wax coating.

17. The beverage container of claim 15, wherein the wax coating extends from the base of the body to about two centimeters from the top portion.

18. The beverage container of claim 15, wherein the wax coating is a paraffin wax.

19. The beverage container of claim 15, wherein the top portion has an inner and outer radius.

20. The beverage container of claim 15, wherein the beverage container is a shot glass.
